(19) United States
(12) Patent Application Publication
(10) Pub. No.: US 2025/0356378 A1
(43) Pub. Date: Nov. 20, 2025

(54) Integrated Global Intelligence Platform with Satellite Imagery, Media Analysis, and AI-Driven Insights

(71) Applicants: Abbas Haider, Fredericksburg, VA (US); Robert Davis, Fredericksburg, VA (US)

(72) Inventors: Abbas Haider, Fredericksburg, VA (US); Robert Davis, Fredericksburg, VA (US)

(21) Appl. No.: 18/666,411

(22) Filed: May 16, 2024

(51) Int. Cl. G06Q 30/0201; G06F 40/295; G06F 40/30; G06F 40/58; G06V 20/10; G06V 20/13

(52) U.S. Cl. CPC G06Q 30/0201; G06F 40/295; G06F 40/30; G06F 40/58; G06V 20/13; G06V 20/194

(57) ABSTRACT

A global intelligence platform integrating satellite imagery, media analysis, and AI-driven insights. The system comprises a data integration module for processing real-time data streams, an AI analytics engine with machine learning models for each data type, a data fusion module for correlating insights, and a user interface. The AI engine includes models for analyzing satellite imagery, translating, and summarizing news, and processing social media sentiment. The data fusion module spatiotemporally aligns the heterogeneous data to identify relationships and generate a unified knowledge representation. The user interface enables querying, filtering, and customizing intelligence reports. By leveraging advanced AI techniques and diverse data sources, the invention provides comprehensive, real-time intelligence for decision-makers across various sectors, empowering informed responses to global events, trends, and public sentiment.

### BACKGROUND

The present invention relates to the field of data analytics and intelligence gathering. More specifically, it pertains to a system and method for integrating diverse data sources, including satellite imagery, global media, and social media sentiment analysis, to provide comprehensive, real-time intelligence insights.

In today's rapidly evolving global landscape, timely and accurate intelligence is crucial for informed decision-making across various sectors, from defense and security to business and finance. Existing solutions often focus on specific data sources or offer limited integration capabilities, resulting in a fragmented view of the world's dynamics.

Satellite imagery providers like Planet Labs and Maxar Technologies capture high-resolution images of the Earth's surface, but the raw data requires significant processing and analysis to yield actionable insights. Similarly, while platforms like Babel Street offer multilingual social media monitoring, the insights gained from social sentiment alone may lack the context provided by other data sources.

Attempts have been made to harness artificial intelligence (AI) for data analysis and pattern recognition. For example, US Patent Application US20190138511A1 discloses a system for real-time data processing and content characterization using AI. However, it does not specifically address the integration of satellite imagery with global media and social sentiment data.

Another relevant prior art, WO2016100814A1, describes a method for fusing multi-modal sensor data using deep convolutional neural networks. While it demonstrates the potential of AI in data fusion, it does not encompass the broad range of data sources and applications envisioned in the present invention.

Additionally, U.S. Pat. No. 9,476,730B2 presents a platform for multi-modal 3D geospatial mapping, object recognition, and analytics. Although it incorporates various sensor data types, it lacks the real-time media analysis and sentiment mining capabilities crucial for comprehensive intelligence gathering.

In summary, while existing technologies offer valuable capabilities in data collection, processing, and analysis, there remains a need for an integrated solution that combines diverse data streams, including satellite imagery, global media, and social sentiment, into a unified, real-time intelligence platform. The present invention addresses this need by leveraging advanced AI and data fusion techniques to provide unparalleled insights for a wide range of applications, from defense and security to business intelligence and market analysis.

### SUMMARY

The present invention provides a comprehensive global intelligence platform that integrates diverse real-time data streams, including high-resolution satellite imagery, live news broadcasts, and social media sentiment analysis, to generate actionable insights for a wide range of applications. The system comprises a data integration module that receives and processes data from multiple sources, an AI analytics engine with specialized machine learning models for each data type, a data fusion module that integrates the analyzed data into a unified intelligence report, and a user interface for displaying insights and allowing user interaction.

The AI analytics engine includes a machine learning model trained to analyze satellite imagery and extract relevant geospatial features, an NLP model for translating, summarizing, and extracting key insights from live news broadcasts, and a sentiment analysis model for processing social media data to determine public sentiment and identify trending topics. The data fusion module spatially and temporally aligns the different data modalities, identifies correlations and causal relationships, and generates a unified knowledge representation.

The user interface allows users to specify queries, filter insights based on custom criteria, adjust the granularity of reported information, and provide feedback to refine future intelligence gathering. The system also incorporates robust security measures, including access controls and data encryption.

By leveraging advanced AI techniques and integrating diverse data sources, the present invention offers a powerful tool for decision-makers across various sectors. It enables users to gain a comprehensive, real-time understanding of global events, trends, and public sentiment, empowering them to make informed decisions and respond effectively to emerging situations. The system's scalability and adaptability make it suitable for a wide range of applications, from defense and security to business intelligence and market analysis.

### BRIEF DESCRIPTION OF THE DRAWINGS

The various exemplary embodiments of the present invention. which will become more apparent as the description proceeds, are described in the following detailed description in conjunction with the accompanying drawings, in which:

FIG. 1 is a system architecture diagram illustrating the high-level components of the global intelligence platform system and their interactions.

FIG. 2 illustrates the architecture and key components of the machine learning model for satellite imagery analysis.

FIG. 3 illustrates a schematic diagram of the natural language processing model pipeline configured to process live news broadcasts from a plurality of global media outlets in different countries and regions.

FIG. 4 depicts a flowchart illustrating the sentiment analysis and trending topic identification process applied to real-time social media data.

FIG. 5 depicts user interface wireframes for presenting the generated intelligence reports and allowing user interaction.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein. each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

The word or as used herein means any one member of a particular list and includes any combination of members of that list. Further, one should note that conditional language, such as, among others, “can,” “could,” “might.” or “may.” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more aspects or that one or more particular aspects necessarily include logic for deciding, with or without user input or prompting, whether these features, elements and/or steps are included or are to be performed in any particular aspect.

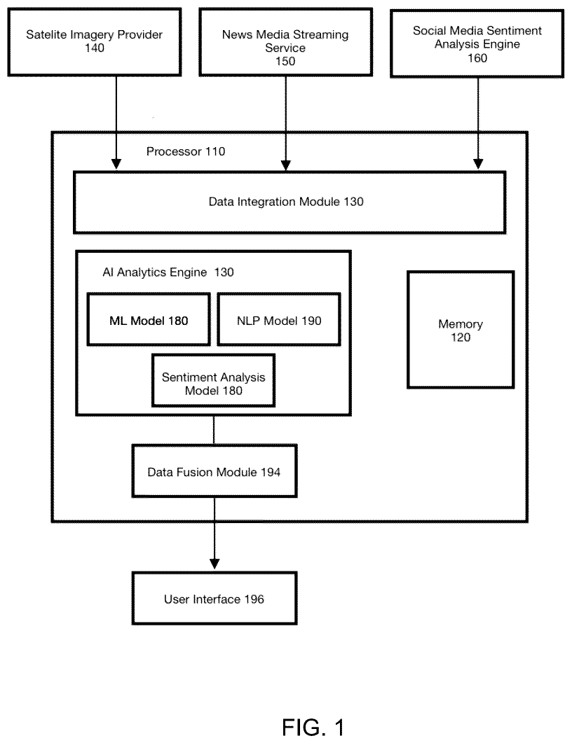

FIG. 1 is a system architecture diagram illustrating the high-level components of the global intelligence platform system and their interactions. The system comprises a processor 110 and a memory 120 storing instructions that, when executed by the processor 110, implement various functional modules. A data integration module 130, implemented by the processor, is configured to receive and process real-time data streams from a plurality of sources. These sources include a satellite imagery provider Application Platform Interface API 140 for receiving high-resolution satellite imagery, such as multispectral imagery captured by WorldView-3 satellites. The data sources also include a global news media streaming service 150, such as Reuters Connect, for receiving live news broadcasts in a plurality of languages. Additionally, the system receives real-time social media data from a social media sentiment analysis engine 160, which may utilize tools like Hootsuite Insights to monitor social media platforms.

The data integration module passes the received data to an AI analytics engine 170. The AI analytics engine comprises a machine learning model 180 trained to analyze the high-resolution satellite imagery to identify and extract relevant geospatial features and generate corresponding textual descriptions. This machine learning model may employ convolutional neural networks (CNNs) and region-based CNNs (R-CNNs) for object detection and classification.

The AI analytics engine also includes a natural language processing (NLP) model 190 that performs real-time translation of the live news broadcasts into a target language, summarizes the translated broadcasts, and extracts key insights. The NLP model 190 can leverage transformer-based architectures like BERT and T5 for translation and summarization tasks.

Furthermore, the AI analytics engine contains a sentiment analysis model 192 that processes the real-time social media data to determine public sentiment and identify trending topics. This model may utilize deep learning approaches such as Long Short-Term Memory networks (LSTMs) and GRUs to classify sentiment.

The extracted geospatial features, textual descriptions, news insights, public sentiment, and trending topics are integrated by a data fusion module 194 into a unified, coherent intelligence report. Finally, a user interface displays 196 the generated intelligence report and allows for user interaction and customization based on specific requirements.

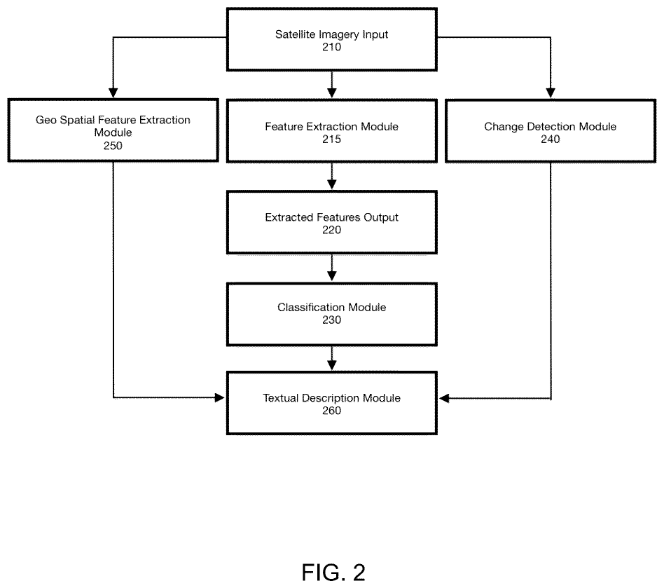

FIG. 2 illustrates the architecture and key components of the machine learning model for satellite imagery analysis. The model takes high-resolution satellite imagery 210 as input, which may include multispectral imagery captured across multiple frequency bands.

The input imagery 210 is processed by a feature extraction module 215, which employs convolutional layers to learn hierarchical features. The extracted features 220 are then passed to an object detection and classification module 230, which utilizes techniques such as Faster R-CNN or YOLO (You Only Look Once) to identify and classify objects of interest within the imagery.

Additionally, a change detection module 240 compares satellite imagery from different time periods to determine changes in identified objects over time. This module may use methods like Siamese networks or change vector analysis to detect and quantify changes.

The machine learning model also includes a geospatial feature extraction module 250 that identifies and extracts relevant geospatial features from the satellite imagery, such as buildings, roads, and land cover types. This module can employ techniques like semantic segmentation using fully convolutional networks (FCNs) or U-Net architectures.

Finally, a textual description generation module 260 produces corresponding textual descriptions of the extracted geospatial features using sequence-to-sequence models with attention, such as the encoder-decoder architecture or transformer-based models like GPT.

The machine learning model is trained using large datasets of annotated satellite imagery, such as SpaceNet or xView, which provide labeled examples of objects and geospatial features. The model is optimized using techniques like transfer learning, data augmentation, and regularization to improve its performance and generalization capabilities.

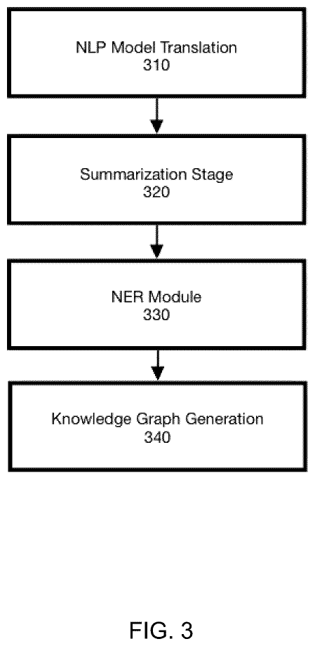

FIG. 3 illustrates a schematic diagram of the natural language processing (NLP) model pipeline configured to process live news broadcasts from a plurality of global media outlets in different countries and regions. The NLP model comprises a series of sequential stages including translation, summarization, named entity recognition, and entity linking. In the first stage 310, the NLP model performs real-time translation of the incoming live news broadcasts, which may be in a plurality of different languages, into a target language using advanced machine translation techniques such as neural machine translation with attention mechanisms. The translated news broadcasts are then fed into the summarization stage 320, which employs extractive and/or abstractive summarization algorithms to generate concise summaries of the news content while preserving the key information.

The summarized news broadcasts are subsequently processed by the named entity recognition (NER) module to identify and extract mentions of key individuals, organizations, locations, and other types of named entities 330. State-of-the-art NER approaches based on deep learning architectures such as Bidirectional Encoder Representations from Transformers (BERT) may be utilized for accurate entity extraction.

Finally, the extracted named entities are linked to corresponding entries in a large-scale knowledge graph or knowledge base 340. The entity linking stage resolves ambiguities and maps the entities to their representations in the knowledge graph, enabling further reasoning and inference over the extracted insights. The knowledge graph itself may be constructed and continuously updated by integrating structured and unstructured data from various reputable sources.

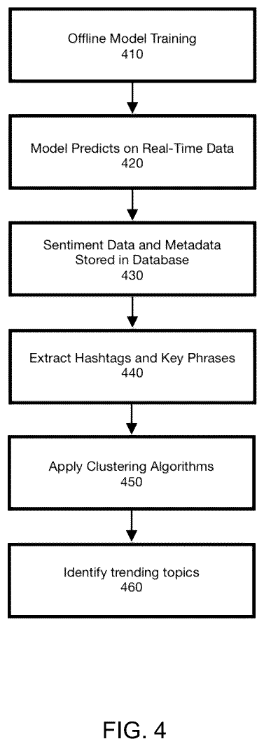

FIG. 4 depicts a flowchart illustrating the sentiment analysis and trending topic identification process applied to real-time social media data. The social media data ingested into the process comprises posts, comments, reactions, and associated metadata collected from a plurality of social media platforms. The sentiment analysis component of the process involves two main steps. First, a sentiment classification model is trained offline on a large, manually curated dataset of social media posts labeled with sentiment scores or categories (e.g., positive, negative, neutral) 410. The training dataset is carefully constructed to include diverse examples covering different domains, languages, and cultural contexts to improve model robustness and generalization. Advanced deep learning architectures such as Transformers and their variants (e.g., BERT, ROBERTa, XLNet) can be leveraged for model training.

Once trained, the sentiment classification model is applied to the incoming real-time social media data to predict the sentiment of each post or comment 420. The model outputs sentiment scores indicating the degree of positive, negative, or neutral sentiment expressed in the text. These sentiment scores, along with the social media metadata, are stored in a distributed database system for efficient retrieval and aggregation 430. In parallel to sentiment analysis, the trending topic identification module extracts hashtags, keywords, and key phrases from the social media data using techniques such as n-gram extraction, TF-IDF weighting, and part-of-speech tagging 440. The frequencies and co-occurrences of the extracted hashtags and keywords are computed to measure their popularity and detect emerging trends.

Clustering algorithms, such as K-means, DBSCAN, or hierarchical clustering, are then applied to group semantically similar hashtags and keywords into distinct trending topics 450. The clustering process takes into account the content similarity, temporal proximity, and user engagement metrics of the social media posts to identify coherent and meaningful topic clusters. The identified trending topics, along with their associated sentiment scores and key posts, provide valuable insights into public opinion and social trends 460.

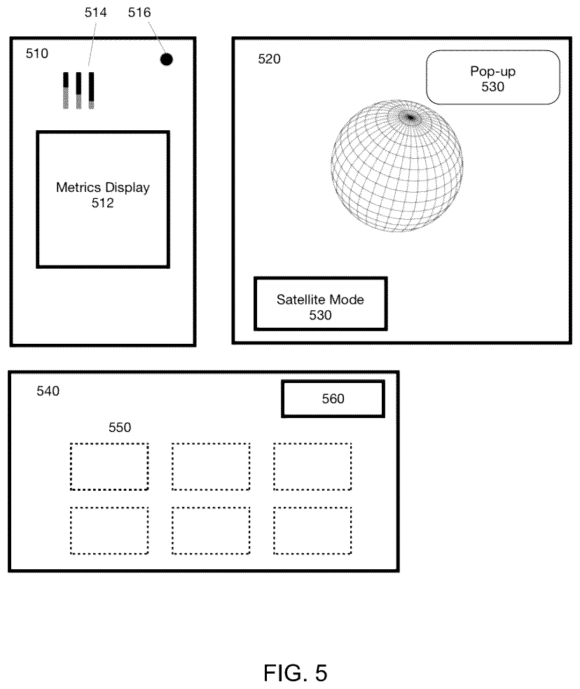

In a preferred embodiment the data fusion is implemented by a processor executing instructions stored in a memory and receives real-time data streams from multiple sources, comprising high-resolution satellite imagery as detailed in FIG. 3, data from live news broadcasts as detailed in FIG. 4, and real-time social media data sentiment analysis engine as detailed in FIG. 5.

The extracted geospatial features and textual descriptions from the satellite imagery analysis, key insights from the translated and summarized news broadcasts, and public sentiment and trending topics from social media are spatially and temporally aligned by the data fusion module. This alignment process involves synchronizing the timestamps and geo-coordinates of the heterogeneous data points to create a unified spatio-temporal reference frame.

The data fusion module employs advanced machine learning algorithms, such as multi-view learning and cross-modal embedding, to identify correlations and causal relationships between the aligned data points. For example, it may discover a correlation between a sudden increase in social media mentions of a disease outbreak in a specific region and the appearance of new temporary medical structures in satellite imagery of that area, indicating a potential epidemic.

The correlated insights are then integrated into a unified knowledge representation, such as a knowledge graph or a multi-modal embedding space, that captures the interconnections and dependencies among the data points. This knowledge representation forms the basis for generating comprehensive intelligence reports.

To ensure secure sharing of the generated intelligence reports, the system incorporates a security module that implements access controls, such as role-based access control (RBAC) or attribute-based access control (ABAC), and data encryption techniques, such as AES-256, to prevent unauthorized access.

FIG. 5 depicts user interface wireframes for presenting the generated intelligence reports and allowing user interaction and customization.

The main dashboard 510 provides an overview of the latest intelligence insights, displaying key metrics 512, visualizations 514, and alerts 516.

The interactive map view 520 enables users to explore geospatial insights by panning and zooming into specific regions of interest. The map features various layers, such as satellite imagery 530 and markers for significant events or anomalies. Users can click on map elements to view more insights and detailed information in pop-up windows 530.

The intelligence report generator 540 enables users to create custom reports by selecting specific insights, data visualizations, and narrative sections. The generator provides a drag-and-drop interface 550 for arranging report elements and supports exporting the reports in various formats, such as PDF, HTML, or interactive web pages. User can generate a report once the interface is configured as per their preference using the generate button 560.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined.

What is claimed is:

1. A method for providing integrated global intelligence, the method comprising:
receiving, via a data integration module, real-time data streams from a plurality of sources, the plurality of sources comprising:
high-resolution satellite imagery from a satellite imagery provider;
live news broadcasts in a plurality of languages from a global news media streaming service; and
real-time social media data from a social media sentiment analysis engine;
analyzing, using a machine learning model of an AI analytics engine, the high-resolution satellite imagery to identify and extract relevant geospatial features and generate corresponding textual descriptions;
processing, using a NLP model of the AI analytics engine, the live news broadcasts by:
performing real-time translation of the live news broadcasts into a target language;
summarizing the translated news broadcasts; and
extracting key insights from the summarized news broadcasts;
determining, using a sentiment analysis model of the AI analytics engine, public sentiment and identifying trending topics based on the real-time social media data;
integrating, via a data fusion module, the extracted geospatial features and textual descriptions, the key insights from the summarized news broadcasts, and the public sentiment and trending topics into a unified, coherent intelligence report; and
presenting, via a user interface, the intelligence report and allowing user interaction and customization based on specific intelligence requirements.

1. The method of claim 1, wherein the high-resolution satellite imagery comprises multispectral imagery captured across multiple frequency bands.

2. The method of claim 1, wherein analyzing the high-resolution satellite imagery further comprises:
applying an object detection model to identify and classify objects of interest;
and determining changes in identified objects over time by comparing satellite imagery from different time periods.

3. The method of claim 1, wherein the live news broadcasts are received from a plurality of global media outlets in different countries and regions.

4. The method of claim 1, wherein processing the live news broadcasts further comprises:
performing named entity recognition to identify key individuals, organizations, and locations mentioned in the news; and
linking recognized named entities to corresponding entities in a knowledge graph.

5. The method of claim 1, wherein the real-time social media data comprises posts, comments, and metadata from a plurality of social media platforms.

6. The method of claim 1, wherein determining public sentiment further comprises:
training a sentiment classification model on a labeled dataset of social media posts; and applying the trained sentiment classification model to the real-time social media data to determine sentiment scores.

7. The method of claim 1, wherein identifying trending topics further comprises:
extracting hashtags and keywords from the real-time social media data;
determining frequencies and co-occurrences of extracted hashtags and keywords; and
clustering hashtags and keywords into distinct trending topics.

8. The method of claim 1, wherein integrating the extracted geospatial features and textual descriptions, the key insights from the summarized news broadcasts, and the public sentiment and trending topics comprises:
spatially and temporally aligning the different data types;
identifying correlations and causal relationships between data points; and
generating a unified knowledge representation that captures the integrated insights.

9. The method of claim 1, wherein the intelligence report is generated in response to a user-specified query, and wherein the user interaction and customization comprises:
filtering the presented insights based on user-defined criteria;
adjusting the granularity and specificity of reported information; and
providing user feedback to refine future intelligence gathering and analysis.

10. The method of claim 1, further comprising:
secure sharing of the generated intelligence reports with authorized parties;
implementing access controls and data encryption to prevent unauthorized access; and
maintaining detailed audit logs of user interactions and data access.

11. A global intelligence platform system comprising:
a processor;
a memory storing instructions that, when executed by the processor, cause the processor to implement:
a data integration module configured to receive and process real-time data streams from a plurality of sources, the plurality of sources comprising:
a satellite imagery provider for receiving high-resolution satellite imagery;
a global news media streaming service for receiving live news broadcasts in a plurality of languages; and
a social media sentiment analysis engine for receiving real-time social media data;
an AI analytics engine comprising:
a machine learning model trained to analyze the high-resolution satellite imagery to identify and extract relevant geospatial features and generate corresponding textual descriptions;
a natural language processing (NLP) model configured to:
perform real-time translation of the live news broadcasts into a target language;
summarize the translated news broadcasts; and
extract key insights from the summarized news broadcasts;
a sentiment analysis model configured to process the real-time social media data to determine public sentiment and identify trending topics;
a data fusion module configured to integrate the extracted geospatial features and textual descriptions, the key insights from the summarized news broadcasts, and the public sentiment and trending topics into a unified, coherent intelligence report; and
a user interface for displaying the intelligence report and allowing user interaction and customization based on specific intelligence requirements.

12. The system of claim 11, wherein the machine learning model of the AI analytics engine is further configured to:
apply an object detection model to identify and classify objects of interest in the high-resolution satellite imagery; and
determine changes in identified objects over time by comparing satellite imagery from different time periods.

13. The system of claim 11, wherein the NLP model of the AI analytics engine is further configured to:
perform named entity recognition to identify key individuals, organizations, and locations mentioned in the live news broadcasts; and
link recognized named entities to corresponding entities in a knowledge graph.

14. The system of claim 11, wherein the sentiment analysis model of the AI analytics engine is trained on a labeled dataset of social media posts and configured to:
apply the trained sentiment classification model to the real-time social media data to determine sentiment scores; and
extract hashtags and keywords from the real-time social media data, determine frequencies and co-occurrences of extracted hashtags and keywords, and cluster hashtags and keywords into distinct trending topics.

15. The system of claim 11, wherein the data fusion module is further configured to:
spatially and temporally align the different data modalities;
identify correlations and causal relationships between data points; and
generate a unified knowledge representation that captures the integrated insights.

16. The system of claim 11, wherein the user interface is further configured to:
receive user-specified queries for generating the intelligence report;
filter the presented insights based on user-defined criteria;
adjust the granularity and specificity of reported information; and
provide user feedback to refine future intelligence gathering and analysis.

17. The system of claim 11, further comprising:
a security module configured to:
securely share the generated intelligence reports with authorized parties;
implement access controls and data encryption to prevent unauthorized access; and
maintain detailed audit logs of user interactions and data access.
